(19) United States
(12) Patent Application Publication
(10) Pub. No.: US 2026/0208845 A1
(43) Pub. Date: Jul. 23, 2026

(54) REMOTE CONTROLLABLE STEERING SYSTEM FOR MARINE VESSELS

(71) Applicant: GLOBAL 1 BILISIM VE ELEKTRONIK SISTEMLERI SANAYI VE TICARET LIMITED SIRKETI, Istanbul (TR)

(72) Inventor: Ergun ALTINTAS, Istanbul (TR)

(73) Assignee: GLOBAL 1 BILISIM VE ELEKTRONIK SISTEMLERI SANAYI VE TICARET LIMITED SIRKETI, Istanbul (TR)

(21) Appl. No.: 19/142,651

(22) PCT Filed: Dec. 25, 2023
(86) PCT No.: PCT/TR2023/051689

§ 371 Date: Jun. 24, 2025

(30) Foreign Application Priority Data
Dec. 26, 2022 (TR) 2022/020504

(51) Int. Cl. B63H 25/04; B63H 25/02; G05D 1/223; G05D 1/248; G05D 109/30; G05D 111/30

(52) U.S. Cl. CPC B63H 25/04; G05D 1/2232; G05D 1/248; B63H 2025/028; B63H 2025/045; G05D 2109/34; G05D 2111/32

(57) ABSTRACT

An automatic remote steering system for watercraft, which is connected to the steering wheel shaft and can be controlled remotely. In the steering system of the invention, the clamping device and the mechanical system box can be easily assembled and disassembled, making the steering system very easy to assemble and disassemble.

### CROSS REFERENCE TO RELATED APPLICATIONS

This application is a national stage entry of International Application No. PCT/TR 2023/051689, filed on Dec. 25, 2023, which is based upon and claims foreign priority to Turkey Patent Application No. 2022/020504, filed on Dec. 26, 2022, the entire contents of which are incorporated herein by reference.

### TECHNICAL FIELD

The invention relates to an automatic remote steering system for watercraft, which is connected to the steering wheel shaft and can be controlled remotely.

### BACKGROUND OF THE INVENTION

In the art, the direction of watercraft is determined by the steering wheel. The steering wheel, which can be resembled to the steering wheel in an automobile, transfers motion to the rudder blade or outboard motor at the rear of the boat with a hydraulic system via the steering wheel shaft.

The automatic control of watercraft is usually achieved by systems consisting of many electronic and mechanical components that are connected to the hydraulic system between the steering wheel and the rudder blade and move the rudder blade (or outboard motor). However, these systems are very difficult and costly to install on the boat. In addition, drilling and assembly operations have to be applied in many parts of the boat for the cables to be located between the parts of these systems.

Another application is the systems attached directly to the steering wheel. These systems do not require any intervention to the hydraulic system on board and provide mechanical steering directly to the steering wheel.

In the known state of the art, the patent document KR102179115 mentions a system that is mechanically connected to the steering wheel of the boat and allows the steering wheel of the boat to be moved remotely in a wireless way.

In the known state of the art, the patent document U.S. Pat. No. 4,244,316 mentions a mechanism for remote steering of a boat steering wheel.

In the known state of the art, patent document U.S. Pat. No. 4,170,953, there is a mention of an attachment to the boat steering wheel for stabilizing the boat steering wheel in a certain direction (autopilot).

In the known state of the art, the document TR 2021 004704 describes an autopilot system for watercraft and a method for doing so. This autopilot system is connected directly to the steering wheel shaft and keeps the vessel in the autopilot position.

In the known state of the art, the patent document US2016016651A1 mentions a steering system that is connected to the rudder blade at the rear of the boat and allows the rudder blade to be moved directly.

When the systems available in the art are examined, it is seen that some systems only transfer motion to the rudder blade. Some systems, on the other hand, only have an autopilot feature while giving motion to the steering wheel, and cannot perform remote wireless communication.

The main problem encountered in systems that both connect to the steering wheel and move the steering wheel with remote wireless communication is that these systems consist of too many parts and have a complicated structure. These systems are difficult and laborious to integrate into the boat. For this reason, there is a need to realize a system that users can even assemble themselves without requiring special expertise.

Another problem encountered is that in order to attach these systems to the steering wheel, it is necessary to drill many holes on the hull and fix the system with screws. When it is desired to remove these systems from the boat, damages will have occurred on the boat. For this reason, it was necessary to develop a system that can be connected to the steering wheel shaft without any damage to the hull and without the use of screws, and that does not leave any traces around the boat steering wheel after the system is removed.

Another problem encountered is that automatic remote steering systems can be unintentionally locked and cause security problems. For this reason, it was necessary to develop a system that can be mechanically deactivated very easily at any time.

Another problem encountered is the inability of steering wheel-controlled systems to hold the steering wheel in the desired position when there is an opposing load on the steering wheel shaft. In a rough or windy sea, the opposing load on the steering wheel shaft is greater. It becomes even more difficult to keep the steering wheel shaft fixed in a certain position. Undesirable situations such as displacement of the parts attached to the steering wheel shaft and loss of position can be encountered. Therefore, there is a need to develop a system that maintains its position even under high counter loads. Possible solutions to meet this need require installation with a permanent hole/cavity in the hull. In addition, these solutions may not be suitable for different boat types. For this reason, there is a need for an opposing load prevention system that can be installed without leaving permanent holes etc. in the hull and that will adapt to different boat models.

### SUMMARY

The object of the present invention is to realize an automatic remote steering system that users can assemble themselves without special expertise.

Another object of the present invention is to realize an automatic remote steering system which can be connected to the steering wheel shaft without damaging the boat and without using screws, and which leaves no marks or holes around the boat steering wheel after the system is removed.

Another object of the present invention to provide an automatic remote steering system which can be easily deactivated at any time, not only electronically but also mechanically.

Another object of the present invention is to realize an automatic remote steering system that maintains its position even under high counter loads, can be installed without damaging the boat and can be applied to different boat models.

### BRIEF DESCRIPTION OF THE DRAWINGS

The automated remote steering system for achieving the objects of the present invention is shown in the accompanying figures.

These figures are;

FIG. 1: Schematic view of the mechanical system box attached to the steering wheel shaft and interacting with the mobile device in the automatic remote steering system of the subject to the invention.

FIG. 2: Schematic view of the subject to the invention in the automatic remote steering system with the clamping device attached to the steering pump and the mechanical system box fixed.

FIG. 3: Schematic front view of the mechanical system box in the automatic remote steering system of the subject to the invention.

FIG. 4: Schematic side view of the mechanical system box in the automatic remote steering system of the subject to the invention. FIG. 5: Detail view of the parts in the mechanical system box in the automatic remote steering system of the subject to the invention.

FIG. 6: Perspective view of the clamping device in the automatic remote steering system of the subject to the invention when connected to the mechanical system box.

FIG. 7: A view of the clamping device in the automatic remote steering system of the subject to the invention in the open position connected to the mechanical system box.

FIG. 8: Open view of the clamping device in the automatic remote steering system according to the subject to the invention.

FIG. 9: A view of the rotationally movable part in the clamping device of the automatic remote steering system of the subject to the invention.

The parts in the figures are numbered one by one and the equivalents of these numbers are given below.
1. Steering system
2. Mechanical system box
3 Clamping device
4. Mobile device
5. Steering wheel
6. Steering pump
7. Steering wheel shaft
8. Motor
9. Motor shaft pulley
10. Belt
11. Endless screw pulley
12. Endless screw
13. Clutch mechanism
14. Worm gear
15. Shaft housing
16. Clutch lever
17. Shaft additional part
18. Micro switch
19. Electronic board
20. Rotationally movable part
21. C-shaped ends

### DETAILED DESCRIPTION OF THE EMBODIMENTS

The invention relates to an automatic remote steering system (1) which is connected to the steering wheel shaft (7) and can be controlled remotely and comprises,

A mechanical system box (2) that is attached to the steering wheel shaft (7) by means of the shaft housing (15) on it and transfers motion to the steering wheel shaft (7),

Clamping device (3) clamped around the steering pump (6) and connected at the other end to the mechanical system box (2),

A motor (8) located in the mechanical system box (2) that provides mechanical movement to the system,

A endless screw (12) connected to the motor (8) and rotated by the motion it receives from the motor (8),
a worm gear (14) with gears on it corresponding to the gears of the endless screw (12), which rotates with the rotation of the endless screw (12) and has a shaft housing (15) on it),
clutch mechanism (13) located at both ends of the endless screw (12), which allows the endless screw (12) to be moved on the vertical axis to separate the endless screw (12) from the worm gear (14),
electronic board (19) allowing remote command to the motor (8).

The inventive automatic remote steering system (1) consists of a motor shaft pulley (9) located at the end of the motor shaft (8).

The inventive automatic remote steering system (1) comprises an endless screw pulley (11) located on the endless screw (12).

The inventive automatic remote steering system (1) comprises a belt (10) located between the motor shaft pulley (9) and the endless screw pulley (11).

The inventive automatic remote steering system (1) comprises clutch levers (16) at the ends of the shaft to which the endless screw (12) is connected. The clutch mechanism (13) can be locked in the appropriate position by horizontalizing the clutch lever (16).

The inventive automatic remote steering system (1) comprises micro switches (18) located on top of the clutch mechanism (13), which provide warning and information according to the position of the clutch.

The inventive automatic remote steering system (1) comprises a shaft additional part (17) for attaching the steering wheel (5) after the mechanical system box (2) is attached to the steering wheel shaft.

The inventive automatic remote steering system (1) comprises a clamping device (3) comprising rotationally movable parts (20) connected to C-shaped ends (21) and movable relative to each other.

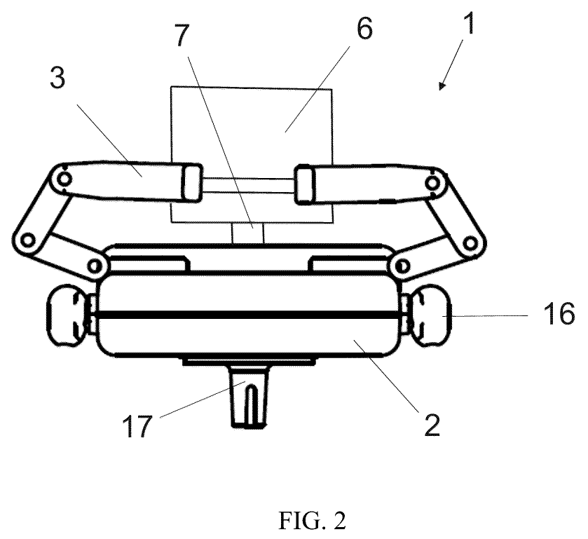

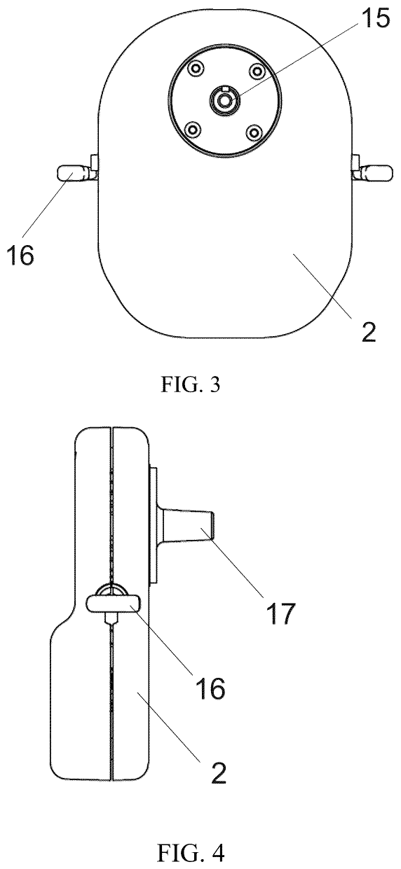

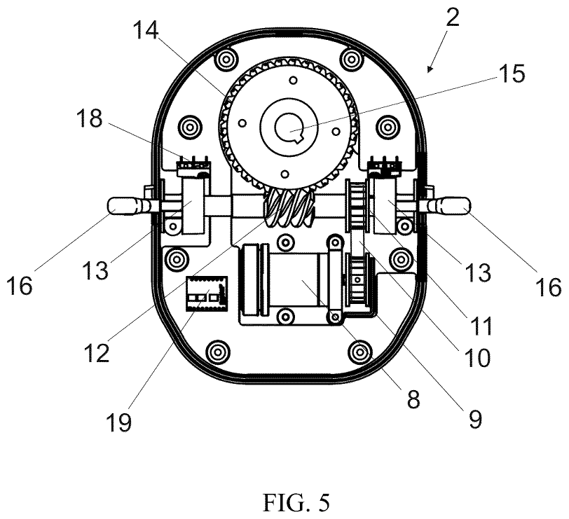

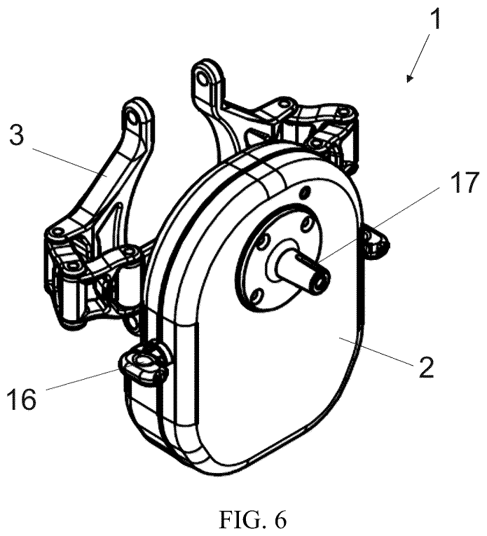

The inventive automatic remote steering system (1) mainly consists of two components; the mechanical system box (2) and the clamping device (3). (FIG. 2 and FIG. 6).

When the steering system (1) is to be connected to the watercraft, the steering wheel (5) is first removed from the steering wheel shaft (7).

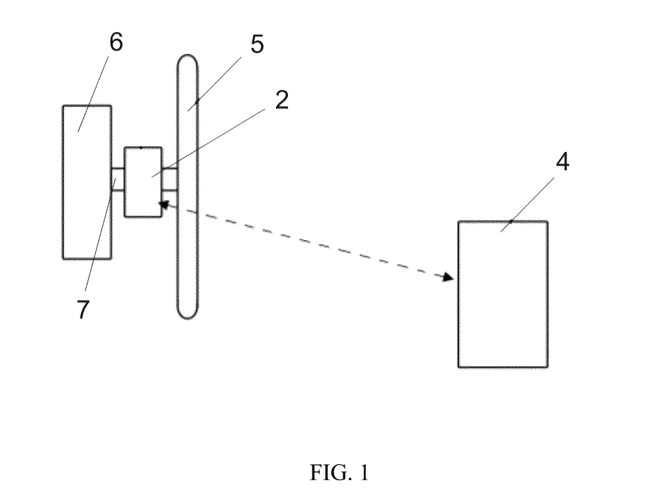

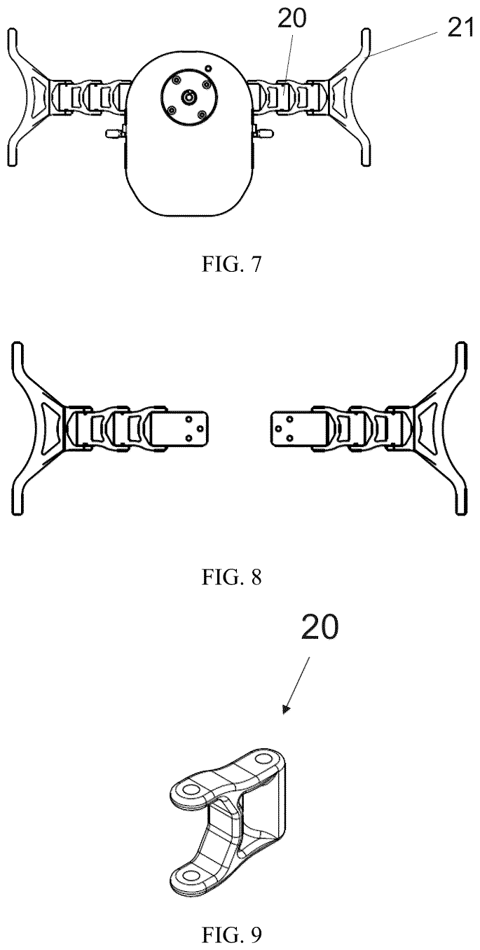

Then, the mechanical system box (2) is threaded onto the steering wheel shaft (7). Here, the mechanical system box (2) is attached to the steering wheel shaft just like a steering wheel by passing the steering wheel shaft (7) through the shaft housing (15) and tightening the wedge and screw of the wheel. The shaft housing (15) is designed in accordance with the diameter of the standard steering wheel shaft (7). (FIG. 1 and FIG. 2) Then, the clamping device (3) is attached and fixed around the steering pump (6) with a clamp system. The clamping device (3) has two opposing ends with a C-shape whose open ends face each other and these C-shaped ends (21) are wrapped around the steering pump (6) and the clamping device (3) is fixed to the steering pump (6) by tightening a threaded screw passed between the C-shaped ends (21). During this process, no drilling or destruction is made around the steering pump (6) or the steering wheel. (FIG. 2 and FIG. 6) The clamping device (3) consists of rotationally movable parts (20) connected to C-shaped ends (21). In this way, even if the diameter and height of the steering pump (6) changes within certain limits, the connection can be made without any problems. (FIG. 2, FIG. 6, FIG. 7 and FIG. 8)

After the mechanical system box (2) is fixed to the steering wheel shaft (7) and the steering pump (6), the steering wheel (5) is attached to the shaft additional part (17) by means of wedge and screw as it was removed. Thus, the assembly of the system is completed.

In the mechanical system box (2), all mechanical movement is provided by the motor (8). The motor (8) is managed by means of an electronic card (19). The electronic board (19) can be managed by wireless communication tools. With a smart mobile device (4), the motor (8) can perform the desired movement through an application suitable for the system.

The rotary motion of the motor (8) is transmitted to the motor shaft pulley (9) located at the motor end, from the motor shaft pulley (9) to the belt (10), from the belt (10) to the endless screw pulley (11) and thus to the endless screw (12). The endless screw (12) transfers the rotary motion to the worm gear (14) and since the worm gear (14) is connected to the steering wheel shaft (7) via the shaft housing (15), the motion in the motor (8) is transferred to the steering wheel shaft (7) in this way. (FIG. 5)

At the ends of the endless screw (12), there are clutch mechanisms (13). These clutch mechanisms (13) move the endless screw (12) in the vertical direction. Therefore, by releasing the clutch mechanisms (13) by making the clutch lever (16) vertical and then moving them downwards, the endless screw (12) and worm gear (14) are disconnected and the system can be deactivated. In order to activate the system, the clutch levers (16) are pulled upwards in the vertical position and locked by moving them to the horizontal position at the top. Micro switches (18) located on the clutch mechanisms (13) give a warning, preferably with a light, when the system is mechanically deactivated by means of the clutch levers (16), checking that the system is fully deactivated.

With an application compatible with the system, it will be possible to move the steering wheel in the desired course and direction, fix it in a certain direction in the autopilot position, and deactivate it at any time with a smart mobile device (4).

The steering system (1) includes a smart mobile device (4) which comprises an application that receives the direction/speed/location information of the boat through all kinds of mobile data means such as Wi-Fi, GPS and Mobile operator coverage, receives the user's commands through the interface on it, calculates a command according to this information and transmits this command to the system box via a wireless network protocol.

When the system is to be removed from the watercraft, in a very simple way, first the steering wheel (5) is removed from the shaft additional part (17) and the mechanical system box (2) is removed from the steering wheel shaft (7). Then the clamping device (3) will be removed from the steering pump (6) by loosening the nuts and the steering wheel (5) will be connected to the steering wheel shaft (7) again and the watercraft will be in its original state.

In the inventive automatic remote steering system (1), the clamping device (3) and the mechanical system box (2) can be easily assembled and disassembled, making the steering system (1) very easy to assemble and disassemble.

In the inventive automatic remote steering system (1), since there is no need to fix the clamping device (3) and the mechanical system box (2) to the watercraft with any screws, a steering system (1) has been realized that can be connected to the boat without any damage to the boat and without the use of screws when the system is connected, and that does not leave any marks or holes around the boat steering wheel after the system is removed.

In the inventive automatic remote steering system (1), a steering system (1) that can be mechanically deactivated very easily at any time thanks to the clutch mechanism (13), clutch levers (16), micro switches (18) and electronic board (19) has been realized.

In the inventive automatic remote steering system (1), a steering system (1) is realized in which the mechanical system box (2) maintains its position even under high counter loads by attaching and fixing the clamping device (3) around the steering pump (6) with a clamp system.

In the automatic remote steering system (1) subject to the invention, a steering system (1) has been realized in which the connection can be made smoothly even if the diameter and height of the steering pump (6) changes within certain limits, without drilling a permanent hole etc. in the boat, thanks to the fact that the clamping device (3) consists of rotationally movable parts (20) connected to C-shaped ends (21) and can move rotationally relative to each other.

The scope of protection of the invention is set out in the appended claims and cannot be strictly limited to what is described in this detailed description for the purpose of illustration. Because it is clear that a person skilled in the art can come up with similar constructions in the light of the above without departing from the main theme of the invention.

1. An automatic remote steering system connected to the steering wheel shaft that is remotely controllable, comprising:
a mechanical system box which is attached to the steering wheel shaft by means of the shaft housing on the mechanical system box and transfers motion to the steering wheel shaft),
a motor located in the mechanical system box and providing mechanical movement to the system,
an endless screw connected to the motor and rotated by the motion received from the motor,
a worm gear comprising gears corresponding to the gears of the endless screw, which rotates with the rotation of the endless screw and has a shaft housing on the worm gear, and
an electronic board allowing remotely commanding the motor,
a clutch mechanism located at both ends of the endless screw, which allows the endless screw to be moved on the vertical axis to separate the endless screw from the worm gear;
wherein
a clamping device clamped around the steering pump and connected at the other end to the mechanical system box has two opposing ends with a C-shape whose open ends face each other, and
the clamping device comprises rotationally movable parts connected to C-shaped ends that are rotationally movable relative to each other.

2. The automatic remote steering system according to claim 1, further comprising a motor shaft pulley located at the end of the motor shaft.

3. The automatic remote steering system according to claim 1, further comprising an endless screw pulley located on the endless screw.

4. The automatic remote steering system according to claim 3, further comprising a belt located between the motor shaft pulley and the endless screw pulley.

5. The automatic remote steering system according to claim 1, further comprising clutch levers at the ends of the shaft to which the endless screw is connected.

6. The automatic remote steering system according to claim 1, further comprising micro-switches located on top of the clutch mechanism and providing alerts and information according to the position of the clutch.

7. The automatic remote steering system according to claim 1, wherein the mechanical system box comprises a shaft additional part for attaching the steering wheel after it is attached to the steering wheel shaft.

8. The automatic remote steering system according to claim 1, further comprising a smart mobile device comprising an application which receives direction/speed/location information of the boat via any mobile data means such as Wi-Fi, GPS and Mobile operator coverage, receives user commands via an interface thereon, calculates a command based on this information and transmits this command to the system box via a wireless network protocol.

9. The automatic remote steering system according to claim 2, further comprising an endless screw pulley located on the endless screw.
